(19) United States
(12) Patent Application Publication
(10) Pub. No.: US 2008/0301064 A1
(43) Pub. Date: Dec. 4, 2008

(54) System and Method for Determining a Real Estate Property Valuation

(76) Inventor: James M. Burns, Huntington, NY (US)

Correspondence Address: DIEHL SERVILLA LLC, 77 BRANT AVE, SUITE 210, CLARK, NJ, 07066, US

(21) Appl. No.: 11/538,996

(22) Filed: Oct. 5, 2006

(51) Int. Cl. G06Q 50/00; G06Q 10/00

(52) U.S. Cl. 705/400

(57) ABSTRACT

Methods and systems for establishing a contemporaneous Real Estate property valuations are disclosed. In accordance with one aspect of the invention, this is based upon first identifying a set of relevant value indicators, or Fields, and then producing a comprehensive Multiple Regression Analysis which statistically measures the relative value of Real Estate properties included in the Set.

### BACKGROUND OF THE INVENTION

The present invention relates to a computer-implemented method and system for identifying valuations of one or more real estate properties. More particularly, the present invention relates to a computer-implemented method for identifying timely and relative valuations of real estate properties. The method and system of the present invention is of interest to owners, buyers, sellers, investors, speculators, mortgagees, renters, realtors, appraisers, builders, tax authorities, taxpayers, financial planners, hedge fund operators, insurance companies, title companies, and other direct and third party participants in the real estate market.

Real estate (“Real Estate”) incorporates the classical statutory definition of real property. Local area Real Estate Multiple Listing Service (“Multiple Listing Service”) organizations typically describe Real Estate properties listed for sale in a manual, electronic format, or a database (“Database”). This is often used by member Real Estate firms.

Properties in this Database are described by a set of fields such as list price, taxes, number of bedrooms, etc. These fields (“Fields”) are the component part descriptions which help explain the various characteristics and hence much of the value of the Real Estate property. One member of these Fields would be a field (“Field”). In New York State, in Suffolk and Nassau counties, the Multiple Listing Service uses a total of as many as 345 Fields to describe a property—however not all Fields are used to describe each property. This data that describes each individual property which is offered for sale is referred to as real estate listing data (“Real Estate Listing Data”). Alternative data sources for similar types of Real Estate Listing Data might be newspaper, internet or similar advertisements.

One item of that data, or Field, the current listing price (“Current Listing Price”) is defined as that offered or list price at which a property is currently offered for sale. An example of the Current Listing Price is reflected in the data provided by the Multiple Listing Service. In practice the Current Listing Price may be described as a discrete data point or as a range between two numbers. Note that this price is subject to negotiation about the actual terms of a specific sale, for example possession, deposit, etc. In an analogous manner, Real Estate data that describes individual properties which are offered for rent is referred to as real estate rental data (“Real Estate Rental Data”). A set of properties selected from the Database with discrete characteristics may be chosen according to some particular criteria, for example: no swimming pool and within a specific group of zip codes and with a Current List Price below a specified limit. One can call such a selected group of properties a set (“Set”).

The prior art methods of Real Estate valuation are episodic and undisciplined. Realtors, and other Real Estate valuation Appraisers or Appraiser (“Appraiser” or “Appraisers”), typically depend on comparing recently sold, locally nearby, similar properties as justifications for judging value. Valuations are typically arrived at without a defined, repeatable process. Sometimes such comparable properties are weighted and averaged. More frequently, the Appraiser's “feel” or “gut instinct” is applied and a judgment is simply pronounced.

The prior art method of Real Estate valuation is undisciplined in several aspects. For example, whether a previously sold property is close enough in time to the present moment, or whether a previously sold property has equivalent location, lot size, living space, room types and sizes and other attributes of a Real Estate property is a completely subjective and unanchored decision method. Different Appraisers make entirely different subjective judgments.

The prior art method of Real Estate valuation is episodic because a realtor typically has a higher degree of personal familiarity in limited specific areas. This familiarity cannot and does not extend to broader areas radiating out in all directions from the Realtor's office. Consequently, the realtor is less familiar and knowledgeable in all areas, and whatever value they may contribute to an appraisal process is clearly not homogenous over the larger Real Estate market. Thus, current valuation techniques are episodic in accuracy and significance.

As a result, valuation techniques often vary widely from Appraiser to Appraiser, and the fact that there are different Appraisers means that the types of error introduced are neither uniform nor consistent. Consequently, there is no statistical merit or relevance in the comparison of two differently appraised properties by different Appraisers.

The following patents describe various aspects of real estate valuations: U.S. Pat. No. 5,636,117 to Rothstein; U.S. Pat. No. 5,857,174 to Dugan; U.S. Pat. No. 6,564,190 to Dubner; and United States Patent Publication No. 20010039506 to Robbins.

The following articles describe various aspects of real estate valuations: “The Correct Use of Confidence Intervals and Regression Analysis in Determining the Value of Residential Homes,” by Donald R. Epley, William Burns; Journal of the American Real Estate and Urban Economics Association, Volume 6, Issue 1, 1978; “Narrow versus Wide Stratification of Data in the Development of Regression Appraisal Models,” by T. Gregory Morton; American Real Estate and Urban Economics Association Journal Volume 4, Issue 2, 1976; “Analyzing the Temporal Stability of Appraisal Model Coefficients: An Application of Ridge Regression Techniques,” by James S. Moore, Alan K. Reichert, Chien-Ching Cho; Areuea Journal, Volume 12 Issue 1, 1984; “Market Microstructure and Real Estate Returns,” by Ko Wang, John Erickson, George W. Gau, Su Han Chan; Real Estate Economics, Volume 23, Issue 1, 1995; Statistical Analysis for Decision Makers, Morris Hamburg, 4^{th} Edition, Harcourt, Bruce Jovanovich 1987; and Applied Linear Regression Model, John Netyter, William Wasserman, Michael H. Kunter, Irwin, 1989.

### SUMMARY OF THE INVENTION

In accordance with one aspect of the present invention, a method of establishing a valuation of a real estate property is disclosed. In a first step, data on real estate properties currently offered for sale in a preselected area is acquired. The data preferably has a plurality of parameters including a listing price. In a next step, each of the real estate properties is compared to the other real estate properties using at least the listing price to establish the valuation.

In accordance with a further aspect of the present invention, the comparison is performed using a regression analysis or a multiple regression analysis on the plurality of parameters. The listing price of the real estate properties are preferably used as a dependant variable.

In accordance with another aspect of the present invention, the data is from a multiple listing database. Data from other sources can also be used.

The regression analysis of the present invention can be a multiple regression analysis or any other type of regression analysis. Other forms of analysis can also be used. The analysis preferably uses a set of properties and compares each property in the set to all of the other properties in the set using at least the current asking price on the property.

The regression analysis can be performed using all available data, however, this can be computationally difficult. In accordance with one aspect of the present invention, to minimize the computational requirements, the data is analyzed to determine statistically significant parameters which are used in another regression step to arrive at a valuation.

The statistically significant parameters can include, for example, a number of baths, taxes, and lot square footage. The statistically significant parameters will vary depending on the location of the properties being analyzed.

In accordance with a further aspect of the present invention, properties not currently offered for sale are valued using the data generated from the analysis of the properties currently offered for sale. First, data on a real estate property not currently offered for sale in the preselected area is acquired. The data has a plurality of parameters. Then, the real estate property not currently offered for sale is compared to the other real estate properties to establish the valuation.

It is one object of the present invention to provide an improved computer-implemented method for contemporaneously identifying valuations of Real Estate properties which statistically measures the relative value of Real Estate properties included in the Set.

It is a further object of the present invention to provide an improved computer-implemented method for contemporaneously identifying valuations of Real Estate properties which statistically measures the relative value of Real Estate properties included in the Set and may extend to properties which might later be added to this Set.

It is a further object of the present invention to describe this method so that it may be implemented to provide timely and relative results which may augment Real Estate related financial decisions.

It is a further object of the present invention to help identify the degree to which a property is undervalued or overvalued, relative to the current listed price, in a Set of properties.

It is a further object of the present invention to identify properties in a Set of properties which have assessed tax amounts which are inconsistently high or low for a given area.

It is a further object of the present invention to quantify the amount by which a property in a Set of properties is undervalued or overvalued.

It is a further object of the present invention to quantify the specific financial contribution which one or more Fields of a property in a Set of properties contributes to the overall Current Listing Price value of the property.

It is a further object of the present invention to use the solved results of the Multiple Regression Analysis, discussed below, to help predict one or more Field values, defined below, on a property by property basis, for properties in the Set or added to the Set.

It is a further object of the present invention to produce a derivative analysis using a Nested Multiple Regression Model as described below.

It is a further object of the present invention to introduce a method whereby a subjective, yet consistent, valuation Field may be considered and subjected to a validation process for possible inclusion into the Regression Model.

It is a further object of the present invention to apply the same objectives and achieve the same benefits when applying the present invention to the offered rental prices of Real Estate properties.

### BRIEF DESCRIPTION OF THE DRAWINGS

Features and advantages of the present invention will become apparent to those skilled in the art from the following description with reference to the drawings, in which:

FIG. 1 is a diagrammatic presentation of the process steps and the actions in accordance with one aspect of the method of the present invention, including determining the component parts or Fields which help explain Real Estate property valuation and subsequently use them to identify consistent contemporaneously valuations across a Set of Real Estate properties.

FIG. 2 is a diagrammatic presentation of the process steps and the actions in accordance with one aspect of the present invention wherein the component parts or Fields which help explain Real Estate rental values in one Multiple Regression Analysis are determined, and that data is used in a Nested Multiple Regression Model to identify consistent contemporaneously valuations across a Set of Real Estate properties.

FIG. 3 illustrates a chart showing the valuation results using one aspect of the present invention.

FIG. 4 illustrates a system that can be used in accordance with another aspect of the present invention.

### DETAILED DESCRIPTION OF A PREFERRED EMBODIMENT

Several patents and patent applications have described Real Estate appraisal methods, such as U.S. Pat. No. 5,857,174; U.S. Pat. No. 5,414,621; U.S. Pat. No. 6,178,406 B1; U.S. Pat. No. 6,115,694, and U.S. Pat. Application No. 20010039506. These patents/applications follow a similar approach where they first start with values of past transactions of transferred property sales, and then they construct a variety of point systems, common attribute mappings, tax assessment percentages, and statistical analyses for the purpose of estimating a current property value from the comparable recent sales of similar properties.

The prior art approaches have been asking the wrong question. The question should not be “how can one help predict the future sale price of a property from past sale prices.” Rather, the question asked and addressed in the present invention is “how can one uniformly and accurately compare the current marketplace of asking home values right now”. The difference in the perspective of these two questions is analogous to driving the car by looking out the back window (as in the prior art cases) as compared to driving the car by looking out the front window (as in the present invention).

The common approaches of the prior art fail to recognize a unique and uncommon understanding, and very important point, that the current asking prices themselves may be viewed so as to comprise a market.

To overcome the limitations in the prior art, the present invention discloses a method and system for identifying the relevant component parts which contribute to Real Estate property valuation, and to use those components to provide consistent and meaningful contemporaneously valuations across a population of Real Estate properties. A key factor of the present invention is recognizing that the starting point for this valuation process is not with past transaction values of so-called comparable sales, but rather with the current asking prices, or Current Listing Price.

The market structure (“Market Structure”) of any given trading market may be revealed by examining the following five questions: Who? What? When? Where? And How? Both the New York Stock Exchange and the US Real Estate market are both examples of order driven markets. The present invention recognizes that most of the Market Structure questions are either the same or analogous between these two different markets. One area which the present invention focuses upon is: When?

In the New York Stock Exchange, stock prices are all contemporaneous and while the exchanges are open, they are adjusted in real time. Consequently, they are influenced by news, changing interest rates, newly released government data, gossip, etc. The three attributes of (1) information about that market, (2) access to current, that is near real time, pricing and (3) the ability to place an order all combine to make the stock market a viable and thriving market.

The prior art may realistically be characterized by the following Real Estate example. “The last time 110 Main Street sold was two years ago and it sold for X, but someone bought 114 Main Street last week and that was up considerably, and they are both three bedroom townhouses so perhaps 110 Main Street should be up too”. This may sound like a familiar framework for such Real Estate dialog. However, consider substituting Stock Market terms in the above example to help evaluate this statement from a different perspective.

For example, “the last time IBM traded was two years ago and it traded for X, but someone bought HP last week and that was up considerably, and they are both technology companies so perhaps IBM should be up too”. The moment the “when” changes in Market Structure from contemporaneous to “sometime in the past few years”, the whole perception of accuracy, consistency, trustworthiness of information changes. It is not as appealing a market as it was. The familiar Stock Market, without a contemporaneous pricing mechanism, seems like an absurd mechanism. Similarly, the lack of a contemporaneous pricing mechanism in the prior art Market Structure of the Real Estate marketplace challenges the accuracy, consistency and trustworthiness of information about pricing.

Also lacking in this Real Estate example is a mechanism to account for the value of individual features. The lot sizes between these two properties could be significantly different and as there are no other comparable sold transactions in close enough proximity there is no way to determine this difference in value. This is further complicated when one has a significantly bigger lot size and the other has a finished basement. There is no adequate mechanism to determine how these two different features tradeoff in terms of value.

Prior art appraisal methodologies have no mechanism to level set property valuations in a contemporaneous manner. The present invention introduces the focus on contemporaneous pricing. This is achieved by recognizing that the manner in which prior art Appraisers rely on past sales is not only not helpful, but also it is detrimental to the very appraisal process as it necessitates various compensation measures and subjective judgments in an attempt to account for older data and data describing different properties which are not exactly the same.

The present invention introduces the recognition that a Current Listing Price may be used as the dependent variable in a multiple regression analysis (“Multiple Regression Analysis”). The abbreviation MRA (“MRA”) is used to indicate Multiple Regression Analysis. Multiple Regression Analysis is a widely practiced statistical technique used to examine the relationship between the area under examination, the dependent variable, and multiple explanatory, or independent, variables. The computer program SPSS, (originally, Statistical Package for the Social Sciences), is an example of a commercial implementation of Multiple Regression Analysis. This program was first released in the late sixties, and is among the most widely used programs for statistical analysis in social sciences and used in other fields as well. It can be used to implement the present invention as described below. A Multiple Regression Analysis can help establish that a set of independent variables help explain a portion of the variance in a dependent variable at a significant level and can establish the relative predictive importance of independent variables—once they are statistically validated. This may be explained by the general linear regression model, with normal error terms, and the number of independent variables, (p−1), as indicated below.

Yᵢ=m₀+m₁Xᵢ₁+m₂ Xᵢ₂+ . . . +mₚ₋₁ X_{i,(p-1)}+εᵢ

Yᵢ denotes the dependent variable also known as the response variable in the i^{th} trial. In solving this regression model the Current Listing Price for a specific property, on a case by case basis, would be used to represent Yᵢ.

Xᵢ₁, X₁₂ . . . Xᵢ₍ₚ₋₁₎ are the values of the (p−1) independent variables in the ith trial. In solving this regression model these explanatory or independent variables are the known constants for a specific property on a case by case basis that would be the Field value.

m₀, mᵢ . . . m₍ₚ₋₁₎ are parameters of the model, often referred to as the estimated regression coefficients (“Regression Coefficients”). These coefficients are what is solved for by the multiple regression analysis. Note that the solution will provide an intercept coefficient, m₀ and one coefficient mⱼ associated with each independent variable as j ranges from 1 to (p−1). This means that the solution yields a one to one relationship between each independent variable or Field and its solved coefficient.

εᵢ where i ranges from 1 to (p−1) are independent normally distributed error terms with a mean equal to zero and a constant variance.

In a preferred embodiment of the present invention, the dependent variable Yᵢ, chosen to be Current Listing Price in the above equation, is determined to be a function of multiple explanatory independent variables, Xᵢ₁ . . . X₁₂+ . . . X_{i,(p-1)} in the above equation. Each Xᵢⱼ (where j ranges from 1 to (p−1)) represents a selected field (“Selected Field”), or independent variable, which was chosen for use in the Multiple Regression Analysis and was subsequently validated, as explained below, as helping to provide meaningful results. Once candidate Selected Fields have been chosen and are run in the Multiple Regression Analysis for either validation or analysis results, the set of equations and dependent variables and independent variable are said to describe a multiple regression model (“Multiple Regression Model”). Some Fields are binary (“Binary”) and require a yes or no indication like for the existence of a swimming pool. Some Fields are quantitative (“Quantitative”) and have a numerical value like taxes. It should be noted that the Binary Fields are simply a special case of a multi-state Field and that nothing in the present invention should be construed to be limited to a Binary or two-state Field. The Multiple Listing Service data used in this example has not yet needed to employ a multi-state Field other than Binary.

Thus, in accordance with one aspect of the present invention, a plurality of equations for each property with a plurality of unknowns, are solved to determine the factors m. Then other properties that are not currently listed (and therefore have no current asking or listing price) can be valued using the factors m and the data associated with that other property.

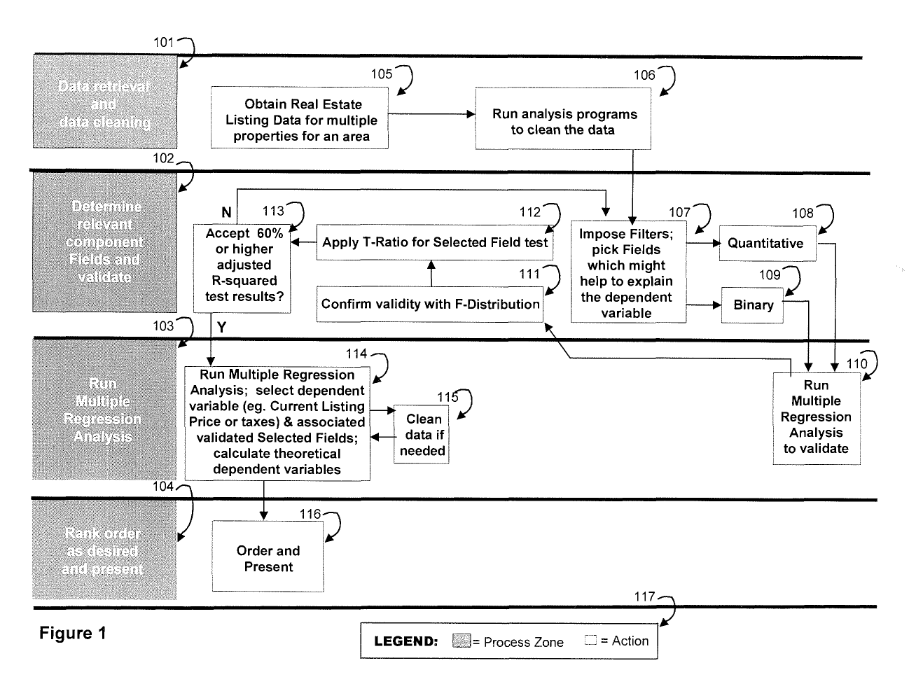

In one of the preferred embodiments of the present invention, FIG. 1 is a diagrammatic presentation of the process steps and the actions that define the method of determining the component parts or Fields which help explain Real Estate property valuation and subsequently use them to identify consistent contemporaneously valuations across a Set of Real Estate properties.

In this figure, the four darker boxes on the left, 101, 102, 103, and 104 presented in a vertical column represent the zones (“Zones”) of four different process steps. A single Zone is the darker box and the area it identifies in the horizontal area or row to the right. The boxes within each Zone represent the action to be taken. The legend 117 of FIG. 1 indicates that the dark boxes, which each begin a new row, or Zone, denote the process step across that Zone, while the white boxes, within Zones, denote action steps. Each action step is now discussed. Action steps sometimes cross zones.

The method of the present invention starts in the Data Retrieval and Cleaning Zone 101. The first action of the method is to acquire the Real Estate Listing Data which includes data representing Field values for a plurality of properties 105. In an embodiment of the present invention, this data was obtained from a local Multiple Listing Service Database. While this is a convenient source it is not a necessary source. It is preferred to practice the present invention with at least thirty or more property descriptions in the Multiple Regression Analysis that can be derived from a variety of sources. In the practice of the present invention, the acquisition of data is a frequently updated event—run daily and as needed during the day to support research and analysis—and either the entire Database may be downloaded or updates to the Database may be merged into a locally stored private database (“Private Database”). The format of the locally stored copy of the Database is not significant to the practice of this invention, except to say that it is a standard relational database typically used by technical practitioners in the industry.

Once acquired, the data needs to be cleaned by running some analysis programs 106. This cleaning is necessary as the source of the data usually emanates from a manual entry process with inconsistent data verification monitoring and this data has an observable frequency of errors. These errors take the form of missing Fields, or numerical figures—like taxes or lot size or asking price—being missing or off by a factor of ten for example. The analysis programs can identify data records with Fields which might be cross-checked with one another, like lot size and lot square footage for example.

The next step is to select a dependent variable which is the topic of investigation, and to assume a set of candidate independent variables, which may represent the major value determinants of that dependent variable. The topic of investigation here is the Current Listing Price as that is chosen as the dependent variable in this analysis. A set of independent variables is then chosen as candidate variables which might help explain the value of the dependent variable. One can assume a set of Fields, candidate independent variables, which may represent the major value determinants, that is the explanatory variables 107. These Fields or independent variables are chosen based on the practitioner's combined knowledge of the Real Estate market in general and localized knowledge. An example of the knowledge of the Real Estate market in general would be that taxes, the number of bedrooms, the number of bathrooms and lot size are likely to be four important Fields contributing to a property's value. An example of localized knowledge would be that the Fields for “water view” or “waterfront’ may be important in Florida for Palm Beach listings, but not important in Nevada for Las Vegas listings. The Fields are then considered chosen candidate independent or explanatory variables, and the Current Listing Price is the chosen dependent variable. At this point some additional property Fields are used as filters (“Filters”) so as not to include unwanted properties, or alternatively to select properties according to some desired criterion or criteria 107. For example, one might restrict properties to a single town, or avoid properties which are multiple family properties, or use Filters for the presence or absence of a swimming pool. The Filters may also be chosen to select logical or geographic preferences, like a specific zip code, or geographically adjacent zip codes, or a specific town or county for example.

Please note that the Fields may be Quantitative 108 as example for lot size or taxes, or Binary 109 as example for waterfront. Regardless of whether a Field is Binary or Quantitative these Fields may be included in the Multiple Regression Analysis. Then the Multiple Regression Analysis 110 is run.

At this point the validity of the Multiple Regression Analysis can be checked by verifying that the Fields selected are predictive of explaining the dependent variable, in this case the Current Listing Price. To accomplish this one can rely on the analysis of variance statistics, often called ANOVA statistics, provided by the Multiple Regression Analysis. As an overview, verifying validity is accomplished by first performing three standard and well known statistical tests: the F-distribution test 111 to measure the overall validity of the total Fields, and then applying T-tests 112 on each candidate Field. Finally the adjusted R² test 113 is applied where acceptance is judged to be an adjusted R² figure of 60% or higher. Each of these three tests are considered in more detail below. In accordance with one aspect of the present invention, these three tests are all calculated or run as part of the same Multiple Regression Analysis.

The F-distribution test determines the significance of the Multiple Regression Model as a whole. It is a statistical measure of the spread or variability of multiple Field samples. The calculated F statistic from the Multiple Regression Analysis's ANOVA statistics is a function of three things: the R² value, the number of independent variables or candidate Selected Fields used, and the number of cases or properties included in the analysis. The calculated R² value reflects the percent of the variance in the dependent variable (in this example Current Listing Price) which is either uniquely or jointly explained by the independent variables (in this example the Selected Fields). The calculated F statistic value 111 is compared to the corresponding entry on a table of F-distribution values at the 95% confidence level. F-distribution tables are available in most statistical texts. If the calculated value exceeds the table value the Multiple Regression Model is not rejected, but is tentatively accepted pending the adjusted R² evaluation.

The well known statistical process of Student T-test, or T-test 112 is next used to assess the significance of each of the individual variables (or Selected Fields). The T-test is a test of just the unique variance portion of the independent variable, not a test of any jointly explained variance in concert with other independent variables. Any independent variable or specific Selected Field which is not significant at the 95% confidence level is dropped from the Multiple Regression Model.

At a given probability level, say p=0.05 which corresponds to a 95% confidence level, whenever the calculated t statistic from the Multiple Regression Analysis results exceeds the appropriate value found in the standard and published t tables, a Field is judged to be accepted or have validity. When this occurs one knows that the independent variable or Selected Field significantly helps explain a portion of the independent variable or Current Listing Price in this example, and should be included in the Multiple Regression Analysis 114. In this way one can validate that the specific Selected Field is statistically significant and it helps explain the dependant variable value and that it should be included in the Multiple Regression Analysis.

In an embodiment of the present invention, the Multiple Regression Analysis results for the entire geographic region and for specific smaller subset regions have typically used from three to eight Fields—or independent variables. In these instances with an adjusted R²value of about 60% or higher of the dependent variable, the Current Listing Price, can be explained by these three to eight Fields.

In an embodiment of the present invention, it was found convenient to add Filters, as discussed above, which can simultaneously Filter for specific Fields such as a particular school district, zip code or codes, or municipality, for example. Filters are related to Fields as selected, but Filters and Selected Fields are not mutually exclusive for a specific Field. For example: one might select as a Filter a limit on the value of annual taxes at $24,000 per year and at the same time choose taxes as a Selected Field and an independent variable to help predict the selected dependent variable of Current Listing Price.

Some Real Estate data providers, for example, the Multiple Listing Service used in an embodiment of the present invention, supply data which also includes some optional text Fields. These provide a means where the listing realtor may optionally add comments such as: home in “as is” condition, or seller anxious, or lot may be subdivided, for example. These comments may also be used for filtering.

Next a decision point 113 needs to be determined to see if there is both a sufficient number of and quality of Selected Fields included in the Multiple Regression Analysis. The criterion used in a preferred embodiment of the present invention is to achieve an adjusted R2 value of at least 60% or higher. Higher is better. As discussed above, the R² calculation helps explain the individual and the joint contributions from independent variables. In this sense R² is more global than the T-test. Standard Multiple Regression Analysis software is used to obtain the adjusted R² value. In an embodiment of the present invention, while 60% adjusted R² was the cutoff criterion, most frequent values for validated Multiple Regression Models were mid seventy to mid eighty percent.

Next the Multiple Regression Analysis is run 114, and this now validated analysis results in the validated Regression Model. This is done in the present example selecting the Current Listing Price as a dependent variable and the Selected Fields, which are now validated Selected Fields, as the independent variables.

The general solution to Multiple Regression Analysis has now been arrived at and validated. Now, an expression of this equation may now be used as a vehicle to employ the Regression Coefficients solved in that analysis and thus calculate a theoretical value for the dependent variable for any specific property from the Set of properties used in arriving at the model. This theoretical value of the dependent variable for that property is therefore consistent with all of the data used in the Regression Model.

Consider the ith property which was present in the data Set used in the creation of this model. A theoretical dependent variable value, sometimes called the fitted or predicted value, is obtained based on the calculated Regression Coefficients of the model and their associated independent variables. The equation terms are now interpreted as discrete data points associated with a single specific property.

Ŷᵢ=m₀+m₁ Xᵢ₁+m₂ X₁₂+ . . . +mₚ₋₁ X_{i,(p-1)}

where each m has now been solved in the Regression Model and is known, and each Xᵢ, is known for the specific property.

In this use the Current Listing Price of the specific property is unused, and a new predicted or theoretical listing price (“Theoretical Listing Price”) for that property is the calculated result. This calculated result is now consistent with the entire Set of data that comprises the Regression Model.

After the results of the Multiple Regression Analysis are complete, an examination of the properties whose dependant variable, Current Listing Price in this example, most deviates from the Theatrical Listing Price value, may reveal previously selected independent variables, i.e. Selected Fields, whose data needs to be cleaned 115. This examination may be performed visually, or programmatically, or both.

In the practice of the current invention it was found to be convenient to order the properties by the degree to which they are undervalued or overvalued when using the Theoretical Listing Price. In this ordering still making use of our example of using Current Listing Price as the dependent variable, properties are ranked by the percentage by which they are undervalued with the most undervalued properties at the top of the list and the most overvalued properties at the bottom of the list. This percentage is the difference between the Theoretical Listing Price Field minus the observed and Current Listing Price Field (i.e. the numerator), divided by the Current Listing Price Field (the denominator). When this ordering is complete, properties at either end of the list are often found to be extreme observations, or outliers, and the data on which they are based should be examined for accuracy and completeness. After this additional data cleaning, the Multiple Regression Analysis 114 is run again.

After a clean Multiple Regression Analysis is complete the properties can be presented in whatever presentation style is desired 116, in the case of an embodiment of the present invention, this is by order of undervalued properties discussed above.

The present invention also discloses how to calculate the predicted value of any single Field, for a single Real Estate property in the associated data Set. For example, to consider taxes, one would select the Field taxes as dependent variable and creating a Regression Model with taxes as the dependent variable and a set of Selected Fields as independent variables which would need to be validated as discussed above. In this way values for theoretical taxes could be calculated in the same way as discussed above for the Current Listing Price and the Theoretical Listing Price. This could be useful in calculating, for example, what the theoretical taxes should be, if a specific property is to be consistent with the rest of this new Regression Model.

An example of how this is achieved is as follows. Consider FIG. 1. Suppose one were to practice the present invention by running a Multiple Regression Analysis using the Field, taxes, as the dependent variable 114. The description of how to choose Selected Fields from the full rage of Fields, and how to validate those Selected Fields was described previously. Note that the Selected Fields as independent variables chosen to help predict the dependent variable taxes are not necessarily the same as the Selected Fields as independent variables chosen to help predict the dependent variable Current Listing Price.

Those skilled in the art will recognize that a plurality of different contemporaneous Multiple Regression Analysis solutions may be solved each having a different dependent variable Field, and Filters, and each having a different mix of Selected Fields as independent variables chosen to help predict the dependent variable, where each Selected Field as an independent variable was validated using the T-test, and the Multiple Regression Model on the whole was validated using the F-distribution test and the adjusted R² test as previously described.

The present invention also discloses that a new property may be approximately valued by using the results of the present Multiple Regression Analysis 114. This is accomplished in the same manner as calculating the Theoretical Listing Price described above. By using the associated data about the new property and substituting those previously calculated coefficient values into the already solved equation. However, for this valuation technique to be meaningful, the added property must exactly conform to the properties used in the creation of the Regression Model. This means that the added property must conform to and satisfy all of the Filters used, including geographical region as the other properties in the Multiple Regression Analysis.

In another embodiment of the present invention, which also uses the Real Estate market for illustration purposes, the present invention introduces iterative or nested relationships between three different Multiple Regression Analyses. As an overview, this works as follows. The three different Regression Models are referred to as Original-1, Contributory-2, and Altered-Original-3.

In the Original-1 the regression in which the dependent variable is the Current Listing Price is validated and solved for a set of Regression Coefficients associated with the Selected Fields, for a Set of Real Estate properties. This uses the same method as discussed previously and in fact this was our previous example. Thus this example has been validated with the three validation tests described earlier. Suppose, however, one wishes to improve upon the aggregate adjusted R² score by adding another independent variable—yet one has tried and rejected all the other variables. One might elect to construct a new independent variable based, for example, on a theoretical rental price as follows. A second Regression Model, previously named Contributory-2, uses a different dependent variable, for example, using a Field from a Database of Real Estate Rental Data, specifically the property rental price, which is the price at which the property is offered for rent. This model is validated and solved for a set of different Selected Fields for a Set of Real Estate properties. It is important to note that this Contributory-2 Set of Real Estate properties should conform to the same geographical area and the same criteria for Filters used in the Original-1. This analysis is completed using the same method as discussed previously. Then the independent variable Regression Coefficients of the Contributory-2, the predicted or theoretical rental price, solution are then applied to the Original-1 Database of Real Estate Listing Data listed properties, on a property by property basis. In this way a single new Field, theoretical rental price, is calculated for each property in Original-1. If this new Field is incorporated into Original-1, then this results in Altered-Original-3 which is then validated to insure that this new Field at least equals or improves the validation statistics in each of the three cases, F-Distribution, T-test, and adjusted R² value. This use of one Multiple Regression Analysis to create a new Selected Field for a subsequent Multiple Regression Analysis is called a nested Multiple Regression Model (“Nested Multiple Regression Model”).

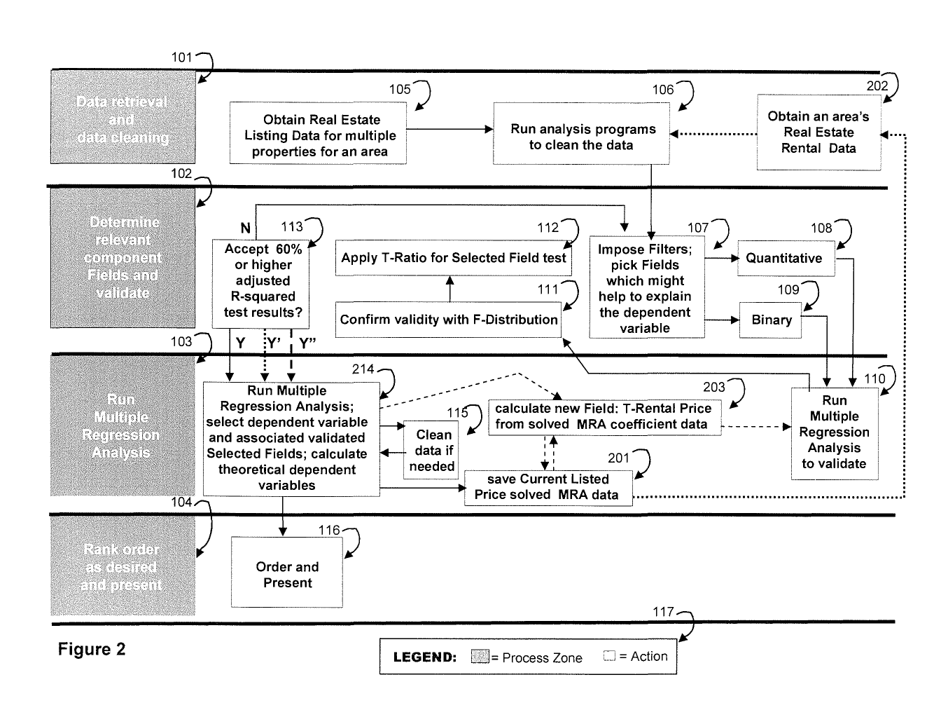

A detailed example of a Nested Multiple Regression Model is now described referring to FIG. 2. FIG. 2 is very similar to FIG. 1, except that three new action boxes, 201, 202, and 203 have been added, and box 114 has been replaced by box 214 in the same position. Note that action box 214 does not assume that the same dependent variable will be chosen from Multiple Regression Analysis run to Multiple Regression Analysis run. Note also that there are three separate and serial decisions, corresponding to three separate Multiple Regression Model validations, represented by the Y (solid), Y′ (dotted) and Y″ (dashed) lines routing from 113 to 214. Using the above Regression Model names: Original-1 takes the Y path; Contributory-2 takes the Y′ path, Altered-Original-3 takes the Y′ path.

Suppose one practices the present invention by running a Multiple Regression Analysis using the Field, Current Listing Price, as the dependent variable 214. This activity is shown in FIG. 2, and it assumes that one has practiced all the previous steps 105, 106, 107, 108, 109, 110, 111, 112, 113, as previously discussed. At 113 after the final validation criterion is satisfied one takes the, yes, Y path to 214.

Next, after the data is cleaned 115, if necessary, the Current Listed Price or Original-1 214 solution and Regression Coefficient values are saved in a storage location 201 for future calculations.

From here, proceed to the starting point of a new Multiple Regression Analysis (Contributory-2) 202 where one obtains a Database of Real Estate Rental Data and extract rental price data for properties that have the same location constraints and the same Filters as previously employed in Original-1 which was created and saved in 201. Then all the previous steps 106, 107, 108, 109, 110, 111, 112, 113, are practiced as previously discussed. At 113 after the final validation criterion is satisfied one takes the, yes, Y′ path to 214.

Now at 214 after the Contributor-2 Regression Model is solved, transition to action box 203. At this point one next calculates a theoretical rental price using the Contributory-2 Regression Coefficient data just solved in Y′ 214. Then calculate this theoretical rental price for each property in the Set of properties previously run after the Y 214 transition which were previously stored in 201. Since the method has been previously constrained to the same Filters and the same geographic areas for all three of these Multiple Regression Analysis, this application will be valid. This calculation creates a new Field value for each property, which can be called theoretical rental price, or T-rental price (“T-Rental Price”). The new Field can now be considered to be an independent variable and a Selected Field and it is added to the Original-1 Regression Model which is now referred to as Altered-Original-3, which was stored in 201. Then the validation process is started over again by moving from 203 to 110.

One then practices all the previous steps 110, 111, 112, 113, as previously discussed. At 113 after the final validation criterion is satisfied one takes the, yes, Y″ path to 214. Next, one cleans the data 115, if necessary, and then moves to 116 for presentation.

In summary, the Regression Coefficients of the solution derived in the Y′ 214 analysis using the Real Estate Rental Data property data base, are used to calculate a new Field 203, T-Rental Price, which is then, added into a previous Multiple Regression Analysis Y 214 (that is Original-1) using the Real Estate Listing Data property Database. Those calculated results for the new Field 203 are then added to Original-1 to be validated. After validation the Multiple Regression Analysis Y″ 214 is run. The validation comprises the steps of satisfying the validity tests for T-test 112 and F-Distribution, and adjusted R² 113 discussed previously.

Those skilled in the art will recognize that these steps of adding a nested Field for inclusion into a Multiple Regression Analysis are also applicable to adding multiple Fields and that the present invention is not limited to adding only one nested Field.

In another embodiment of the present invention, which also uses the Real Estate market for illustration purposes, the present invention introduces a method for introducing a valuation Field which has a subjective or intuitive basis. Suppose for a moment that there is a skilled realtor somewhere who can subjectively intuit the curb appeal of a given property. That curb appeal (“Curb Appeal”) defined as the aggregate or esthetic effect of how well a property is cared for in terms of maintenance, landscaping, esthetic presentation, etc. Further suppose that this realtor has personally visited each property to be used in a Regression Model and has recorded a Curb Appeal value, consistently arrived at from the realtor's perspective, for each property. In the same manner as discussed above, this new Field could be included into a previously solved Regression Model and the same validation tests discussed above could be run to determine if this new Field has statistical significance, and if the inclusion of this new Field improves the overall validity of the Regression Model.

Those skilled in the art will recognize that the above discussion for introducing a potential new Field, which has a subjective or intuitive basis, is in fact a general method or process for evaluating and validating a potentially significant new Field into the regression Model. The validity of the potential new Field may be established and it's use may therefore be rejected or accepted—regardless of how that Field was constructed. This enables a practitioner to test a hypothesis that might incorporate a mathematical intuition, for example that the Regression Model might be strengthened by using the mathematical square of the taxes, or the log of the property size or a function of an independent variable—provided that the specific Multiple Regression Analysis model specifications presented above are observed.

Those skilled in the art will recognize that the selection of a Set of properties using a specific criterion or criteria for use with the methods disclosed within the present invention are examples of how to practice the present invention. Some examples of such Sets of properties would include but not be limited to the following: properties that are under contract as of a specific date or date range, properties that underwent a change of listing broker as of a specific date or date range, properties which have changed their Current Listing Price as of a specific date or date range, properties that have a change in notation about the anxiousness or willingness of a seller as of a specific date or date range, properties with swimming pools, or other defining or significant criterion or criteria, with or without specific date limitations. The present invention is not defined by the limitations, conditions, or constraints, or the lack of limitations, conditions, or constraints of the selection criteria used to define an initial Set of properties.

Those skilled in the art will recognize that the present invention is likewise not defined by any limitations, conditions, or constraints, or the lack of limitations, conditions, or constraints of criteria used as operands on the value ranges of the Selected Fields. Some examples of these operands on the Field values might be mathematical operands such as the square of, the square root of, the rate of change of, the inverse of, distance from the mathematical mean, the variance of, etc., and such operands might be thought helpful to achieve a better explanation of the dependent variable in the Multiple Regression Analysis. The above discussion details how the various validity tests can be used to verify if a specific operand, or if a combination of operands, might be helpful in achieving a better explanation, that is a higher adjusted R² value, of the dependent variable.

In the above description, reference is made to the accompanying drawings which form a part hereof, and which illustrate embodiments of the present invention. It is understood that other embodiments may be utilized and structural and operational changes may be made without departing from the scope of the present invention.

For simplicity and illustrative purposes, the statistical tests and analysis used to help explain the present invention are described by referring to the preferred embodiments. However, one of ordinary skill in the art would readily recognize that other statistical tests of an approximately equivalent or better basis which can deliver equivalent, similar, or improved statistical results are equally applicable to, and can be implemented in making a contemporaneous market system for analyzing of Real Estate properties. The present invention is not limited to employing a specific statistical test or analysis, but rather the method used to achieve the results of such tests and analysis.

For simplicity and illustrative purposes, the principles of the present invention are described by referring to the preferred embodiments. However, one of ordinary skill in the art would readily recognize that the same principles are equally applicable to, and can be implemented in, making another contemporaneous market system such as analyzing prices of rental properties or airplanes or jets or ships or automobiles or municipal bonds or other applicable items in different market systems.

Nothing in this specification should be understood to limit this invention to the required use of Real Estate data as a measure of determining valuations. Real Estate pricing is merely an example of a convenient valuation strategy.

In accordance with one aspect of the present invention, a multiple regression analysis is performed on a set of data or parameters representing real estate properties currently being offered for sale, including the current asking price of the real estate property, to determine a valuation of a real estate property. In accordance with other aspects of the present invention, other types of regression analysis can also be performed. Further, other comparing analysis techniques can be used. For example, Cluster Analysis, Factor Analysis, Principal Component Analysis, and Multidimensional Analysis can also be used to analyze the parameters of real estate being currently offered for sale to determine a valuation of one or more real estate properties.

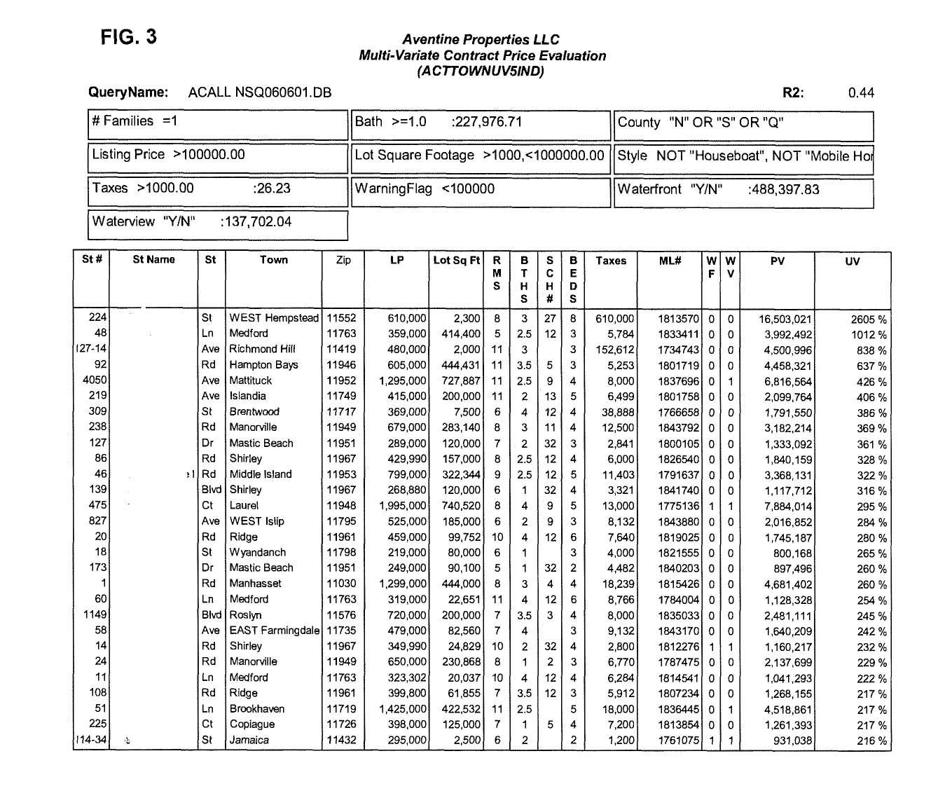

FIG. 3 illustrates a table of real estate valuations. The statistically significant parameters used in the query are identified on top of the figure. They include the taxes, whether the property has a waterview, the number of baths, the lot square footage and others. These parameters can change depending on a number of factors, including location of the properties. The parameters associated with a number of listed properties are shown in FIG. 3. The street names have been omitted. The parameters include RMS (number of rooms), BTHS (number of baths), SCH# (school district information), WF (waterfront) and WV (waterview). ML# is the multiple listing number. The listing price LP is indicated and PV is the determined valuation. UV indicates the amount of undervaluation. The first listing indicates that the property is undervalued by 2605%, but this is unlikely. A review of parameters indicates that the taxes were entered at $610,000, an unlikely number. Thus, the first list can be eliminated by a common sense review of the parameters. Other undervaluations, however, are most likely accurate.

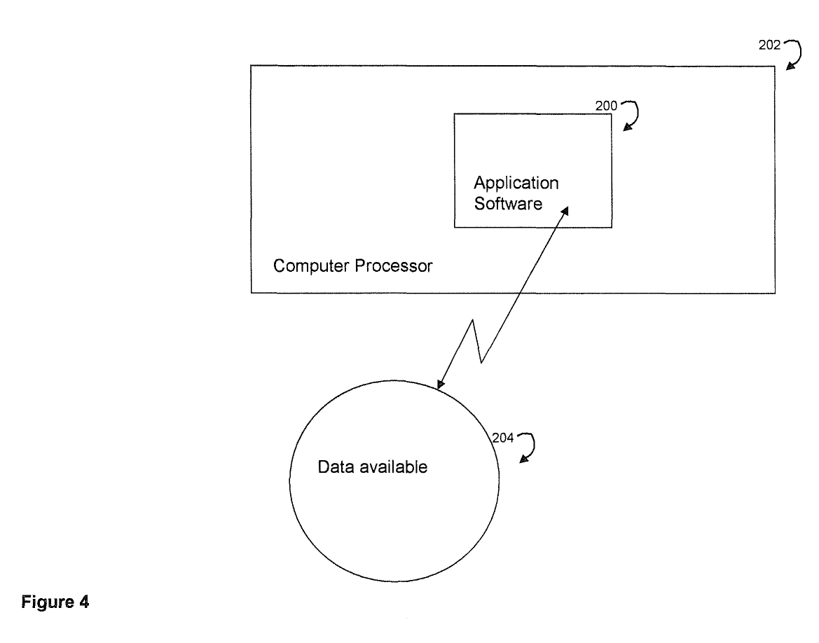

FIG. 4 illustrates a system in accordance with one aspect of the present invention. Application software 200 is operable on a processor 202 to perform the previously described steps. Data 204 is loaded into or available to the processor 202 under the control of the application software 200. The data 204 is preferably from a multiple listing database. The processor 202 can be any type of computer, such as a personal computer, a workstation, parallel processors or the like.

Nothing in this specification should be understood to limit this invention to the required use of the example statistical tests and analysis used as a measure of determining valuations. These statistical techniques are merely examples of a convenient statistical techniques.

In summary, the present invention presents a method for establishing a contemporaneous Real Estate property valuation technique. This is based upon first identifying a set of relevant value indicators, or Fields, and then producing a comprehensive Multiple Regression Analysis which statistically measures the relative value of Real Estate properties included in the Set.

1. A method of establishing a valuation of a real estate property in a preselected area, comprising:
acquiring data relating to a set of real estate properties currently offered for sale in the preselected area, the data having a plurality of parameters including a listing price;
analyzing the data relating to the set of real estate properties including at least the listing price to establish the valuation.

2. The method of claim 1, wherein the step of analyzing performs a regression analysis on the plurality of parameters.

3. The method of claim 1, wherein the step of analyzing performs a multiple regression analysis on the plurality of parameters.

4. The method of claim 3, wherein the listing price of the real estate property is a dependant variable.

5. The method of claim 1, wherein the data is from a multiple listing database.

6. The method of claim 4, wherein the data is from a multiple listing database.

7. The method of claim 3, comprising analyzing the data to determine statistically significant parameters which are used in the analyzing step.

8. The method of claim 7, wherein the statistically significant parameters include a number of baths, taxes, and lot square footage.

9. The method of claim 7, wherein the data is from a multiple listing database.

10. The method of claim 1, wherein the real estate property is not currently offered for sale, comprising:
acquiring data on the real estate property not currently offered for sale, the data having a plurality of parameters;
analyzing the data on the real estate property not currently offered for sale and the data on the set of real estate properties to establish the valuation.

11. A system for establishing a valuation of a real estate property in a preselected area, comprising:
a processor;
application software operable on the processor, the application software operable to:
acquiring data relating to real estate properties currently offered for sale in the preselected area, the data having a plurality of parameters including a listing price;
analyzing the data relating to the set of real estate properties including at least the listing price to establish the valuation.

12. The system of claim 11, wherein the plurality of parameters are analyzed using a regression analysis.

13. The system of claim 11, wherein the plurality of parameters are analyzed using a multiple regression analysis.

14. The system of claim 13, wherein the listing price of the real estate property is a dependant variable.

15. The system of claim 11, wherein the data is from a multiple listing database.

16. The system of claim 14, wherein the data is from a multiple listing database.

17. The system of claim 13, wherein the analysis includes determining statistically significant parameters which are used in the analyzing step.

18. The system of claim 17, wherein the statistically significant parameters include a number of baths, taxes, and lot square footage.

19. The system of claim 17, wherein the data is from a multiple listing database.

20. The system of claim 11, wherein the real estate property is not currently offered for sale and the processor is further operable to:
acquire data on a real estate property not currently offered for sale in the preselected area, the data having a plurality of parameters;
analyzing the data on the real estate property not currently offered for sale and the data on the set of real estate properties to establish the valuation.

21. A method of valuing a parameter associated with a real estate property, comprising:
acquiring data relating to a set of real estate properties currently offered for sale in the preselected area, the data including the parameter;
analyzing the data relating to the set of real estate properties including the parameter using a multiple regression analysis with the parameter as a dependant variable to establish the valuation.
